(19) United States
(12) Patent Application Publication
(10) Pub. No.: US 2004/0094485 A1
(43) Pub. Date: May 20, 2004

(54) Treatment of organic waste

(76) Inventor: Bernard Kevin O'Leary, Leeming Western Australia (AU)

Correspondence Address: BRIGGS AND MORGAN, P.A., 2400 IDS CENTER, MINNEAPOLIS, MN, 55402, US

(21) Appl. No.: 10/472,153

(22) PCT Filed: Mar. 20, 2002
(86) PCT No.: PCT/AU02/00308

(30) Foreign Application Priority Data
Mar. 20, 2001 (AU) PR 3826

(51) Int. Cl. C02F 1/52

(52) U.S. Cl. 210/723

(57) ABSTRACT

A method of treating liquid waste containing inorganic salt and organic matter. The method includes diluting the liquid waste by a large volume of water or clear effluent, and subsequently causing the organic matter to coagulate and form a sludge.

### FIELD OF THE INVENTION

The present invention relates to a treatment of coloured liquid waste.

It is known to require a method of treating coloured liquid waste such as organic waste from a water treatment facility, for instance a magnetic ion exchange water treatment facility. Such waste can have a high salt concentration, a high level of sulphates and a high level of organic material.

Common methods of treating waste containing high levels of organic material are not effective when the waste also contains a high salt concentration. Known methods of treating such waste require expensive processes.

### SUMMARY OF THE INVENTION

In accordance with the present invention there is provided a method of treating aqueous liquid waste containing inorganic salt and organic matter, the method comprising the steps of diluting the liquid waste with aqueous liquid, causing the organic matter to settle and separating the inorganic salt from the organic matter.

### BRIEF DESCRIPTION OF THE DRAWINGS

The present invention will now be described, by way of example, with reference to the accompanying drawings, in which:

FIG. 1 is a flow chart showing the method of the present invention in a first embodiment;

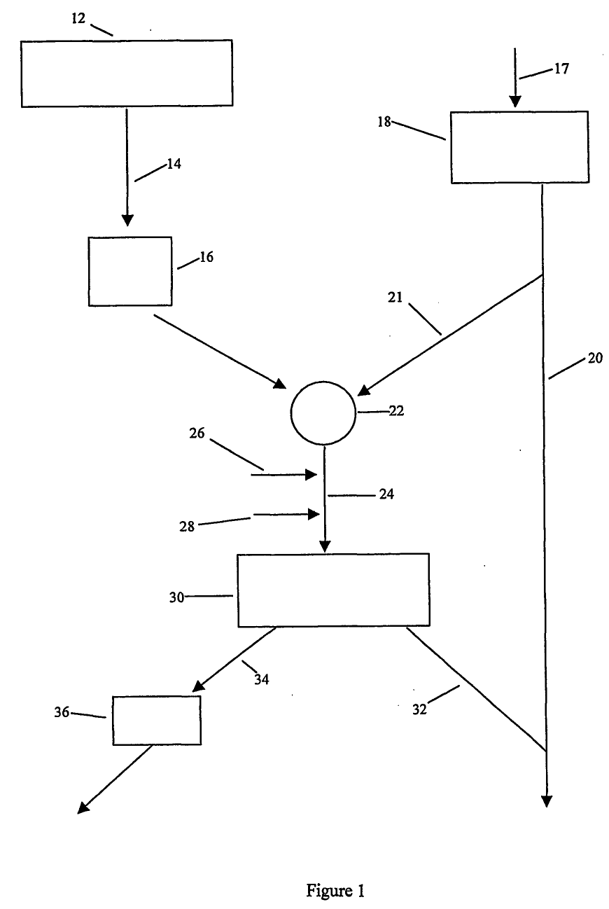

FIG. 2 is a flow chart showing the method of the present invention in a second embodiment; and

FIG. 3 is a flow chart showing the method of the present invention in a third embodiment.

### DESCRIPTION OF THE INVENTION

Referring to the Figures, there is shown a Magnetic Ion Exchange Water Treatment Plant 12, with a waste stream 14. The waste stream 14 typically contains 20 g/L dissolved organic carbon (DOC), 7-20 g/L sulphate and 100 g/L NaCl, although it will be appreciated that the invention may be applied to other concentrations. The waste stream 14 is fed into a balancing storage tank 16. The balancing storage tank 16 is preferably sized so as to contain the waste generated over at least 24 hours.

A waste water treatment plant 18 is also shown, with a wastewater inlet stream 17 and an clear effluent discharge flow 20. The clear effluent discharge flow 20 may be a primary, secondary or higher treatment level effluent discharge flow and is composed of treated waste water, which is in a condition to be discharged to the environment. A proportion of the clear effluent discharge flow 20 is diverted to a tank input stream 21.

The tank input stream 21 and the waste from the balancing storage tank 16 are combined at an interchange 22 to form a combined stream 24. The combination is such that the dilution of the waste by the clear effluent may be in the order of 20:1 to 100:1 by volume.

In an alternative embodiment, the waste stream 14 may be fed directly to the interchange 22, this eliminating the balancing storage tank 16.

The combined stream 24 is typically augmented by the addition of a coagulant 26 such as alum, ferric salts and/or polyelectrolytes. The coagulant 26 may be added to obtain a concentration in the order of 10 to 20 times that of conventional water treatment processes. The concentration of the coagulant 26 can, however, be varied according to the coagulation conditions. A preferred coagulant 26 is ferric chloride used in sufficient quantity to create a concentration of between 300 mg/L and 500 mg/L within the combined stream 24.

After a delay to initiate flocculation, typically about 3 to 5 minutes, the combined stream 24 may be further augmented by the addition of flocculants 28 such as anionic or nonionic polyelectrolytes. The flocculants 28 are added to the combined stream 24 in concentrations similar to that of the coagulant 26, but these concentrations may also be varied according to the flocculation conditions.

A tapered flocculation tank (not shown) may be used if required.

The combined stream 24 is then fed into a clarifier or thickener 30. It will be appreciated that the clarifier or thickener 30 may be replaced with flotation or other separation techniques.

The clarifier 30 acts to separate the combined stream 24 into clarified brine 32 containing sulfates and a sludge 34 containing the organic matter and the added chemicals.

The clarified brine 32 can be released into the environment, for instance into the ocean. The clarified brine 32 may be injected into the effluent discharge flow 20 for release into the environment.

The sludge 34 can be further treated in a sludge thickener 36 or a centrifuge or other dewatering devices before being discharged to be used in landfill. Alternatively, the sludge 34 can be discharged to a lagoon for evaporation of excess water.

A further alternative is for the sludge to be combined with biosolids extracted in the waste water treatment plant 18.

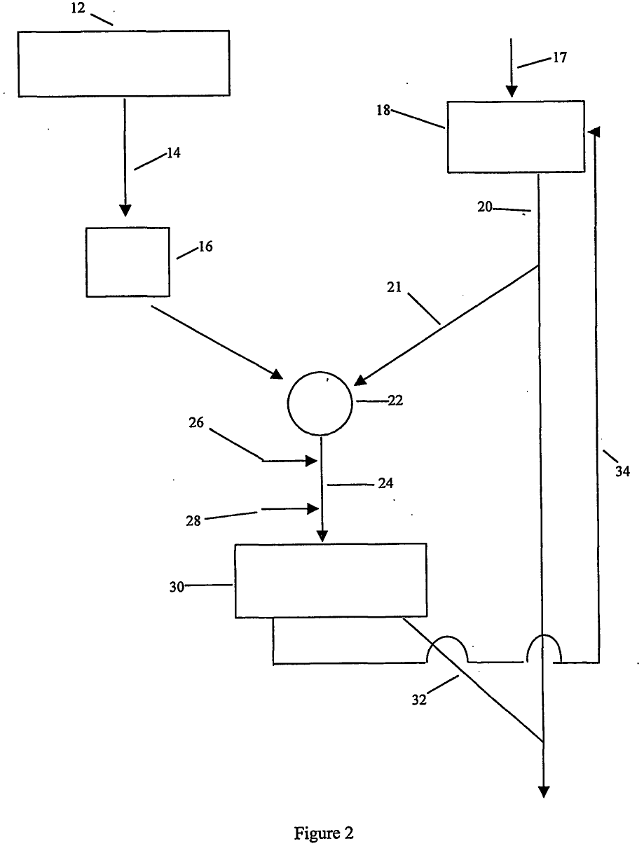

A second embodiment of the present invention is shown in FIG. 2. In this embodiment the sludge 34 is directed to the waste water treatment plant 18 for treatment.

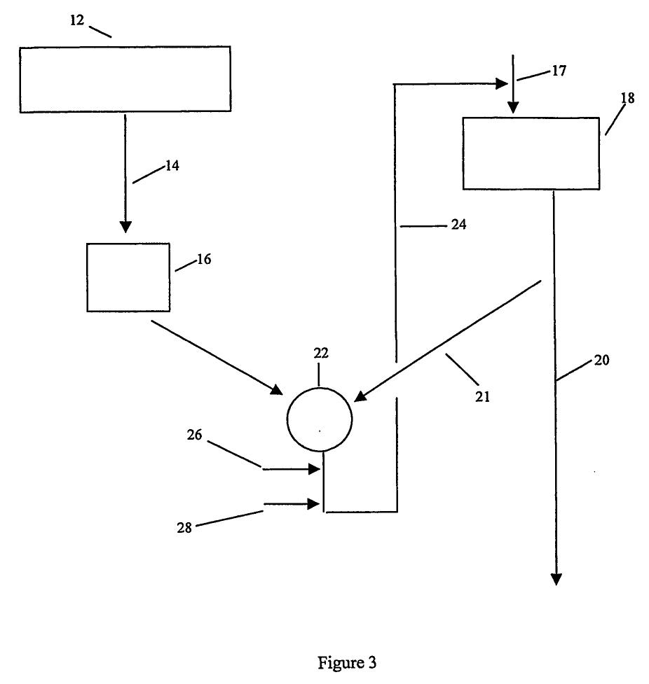

A third embodiment of the present invention is shown in FIG. 3. In this embodiment the combined stream 24, augmented by coagulants 26 and flocculents 28 is directed to the waste water treatment plant 18. In this embodiment the waste water treatment plant 18 replaces the clarifier 30.

Modifications and variations as would be apparent to a skilled addressee are deemed to be within the scope of the present invention.

1. A method of treating aqueous liquid waste containing inorganic salt and organic matter including dissolved organic carbon, the method comprising the steps of diluting the liquid waste with aqueous liquid, causing the organic matter to settle and separating the inorganic salt from the organic matter.

2. A method of treating liquid waste as claimed in claim 1, characterised in that the inorganic salt is sodium chloride.

3. A method of treating liquid waste as claimed in claim 1 or claim 2, characterised in that the liquid waste is diluted by a dilution ratio between 20:1 and 100:1 by volume.

4. A method of treating liquid waste as claimed in any one of the preceding claims, characterised in that the liquid waste is diluted by clear effluent from a waste water treatment plant.

5. A method of treating liquid waste as claimed in any of the preceding claims, characterised in that a coagulant is added to the diluted liquid waste to cause the organic matter to settle.

6. A method of treating liquid waste as claimed in claim 5, characterised in that the coagulant is ferric chloride.

7. A method of treating liquid waste as claimed in claim 6, characterised in that the concentration of the ferric chloride within the diluted liquid waste is in the range from 300 mg/L to 500 mg/L.

8. A method of treating liquid waste as claimed in any one of the preceding claims, characterised in that a flocculant is added to the diluted liquid waste.

9. A method of treating liquid waste as claimed in any of the preceding claims, characterised in that the inorganic salt is separated from the organic matter in a clarifier.

10. A method of treating liquid waste as claimed in any one of claims 1 to 8 characterised in that the inorganic salt is separated from the organic matter in a conventional waste water treatment plant.
